(19) United States
(12) Patent Application Publication
(10) Pub. No.: US 2024/0003154 A1
(43) Pub. Date: Jan. 4, 2024

(54) SEISMIC COMBINATION APPARATUS WITH ELASTOMER AND WITH FRICTION PARTICULARLY FOR USE IN BUILDINGS

(71) Applicants: YILDIZ TEKNIK UNIVERSITESI, Istanbul (TR); YILDIZ TEKNOLOJI TRANSFER OFISI ANONIM SIRKETI, Istanbul (TR)

(72) Inventors: Orkun YILMAZ, Istanbul (TR); Serkan BEKIROGLU, Istanbul (TR)

(73) Assignees: YILDIZ TEKNIK UNIVERSITESI, Istanbul (TR); YILDIZ TEKNOLOJI TRANSFER OFISI ANONIM SIRKETI, Istanbul (TR)

(21) Appl. No.: 18/036,902

(22) PCT Filed: Jun. 4, 2021
(86) PCT No.: PCT/TR2021/050538

§ 371 Date: May 15, 2023

(30) Foreign Application Priority Data
Nov. 13, 2020 (TR) 2020/18195

(51) Int. Cl. E04H 9/02; F16F 13/04

(52) U.S. Cl. CPC E04H 9/022; F16F 13/04; F16F 2230/40; F16F 2222/04

(57) ABSTRACT

A combination apparatus for use in connecting the carrier elements to each other particularly in buildings is provided. Upon providing a flexibility by the building which is not damaged against quake; at least one first inner plate group which can be connected to one of the carrier elements desired to be combined or at least one second inner plate group which can be connected to one other carrier element, at least one outer plate configured to rest said first inner plate group or said second inner plate group towards each other in a tight manner, at least one friction element which can increase rotational resistance with respect to each other, between the first inner plate group and the second inner plate group and between the outer plate and one of the inner plate groups, and at least one hyper-elastic dampening element.

### TECHNICAL FIELD

The present invention relates to a combination apparatus for use in connecting the carrier elements to each other particularly in buildings.

### PRIOR ART

Buildings are closed and essentially multi-compartment structures which are built from resistant materials in order to be used for living or for other purposes. Earthquake is the quakes of the places and the earth by spreading of vibrations, which occur instantaneously due to breakages in the crust, in the form of waves. Earthquakes lead to movement of the ground where persons accept to be motionless and get their feet in a safe manner, and lead to at least partially shake of all structures which exist on the ground. Today, damaging and collapsing of buildings as a result of an earthquake can lead to a big number of deaths and injuries.

In order to avoid damaging of buildings due to quakes like earthquake, the non-damaging condition of some buildings is taken into account and it is allowed that some buildings get damaged with the foreseen amount under the effect of earthquake. In some designs where damage is not needed, the required lateral rigidity and dampening can be provided within specific displacement limits with the insulation units which manage the response of the system under earthquake. In some other designs where damage is not needed, more flexible carrier systems are foreseen and equivalent dampening is formed by using for instance viscose dampeners instead of the desired dampening with the damage and thereby, the effect of the earthquake can be resisted. Another example is to use dampers with friction.

In designs where damage is needed, the dampening provided by the energy which will be eliminated by the damage mechanism forms controlled damage regions and damage formation is allowed in these regions. Damage mechanisms allow formation on specific elements like beams, central lattices and short bond beams of external centered lower systems. In some designs where damaging approach is adopted and which do not exist in regulations or which are very rarely applied, the abovementioned elements, which are allowed to be damaged in controlled damage region, can be changed after earthquake. Thus, the carrier system can be brought to the performance condition which exists prior to earthquake.

In damaged solutions, the obligation to change the damaged apparatus and the high cost of the dampeners which provide equivalent dampening in non-damaged solutions are the biggest disadvantages of the present products.

As a result, because of the abovementioned problems, an improvement is required in the related technical field.

### BRIEF DESCRIPTION OF THE INVENTION

The present invention relates to a combination apparatus for use in connecting the carrier elements to each other particularly in buildings, for eliminating the abovementioned disadvantages and for bringing new advantages to the related technical field.

An object of the present invention is to provide a combination apparatus which provides connection of carrier elements to each other for providing contribution to protection of building in case of quake (at the instant of an earthquake).

Accordingly, the improvement is that upon providing a flexibility by the building which is not damaged against quake, the subject matter combination apparatus comprises at least one first inner plate group which can be connected to one of the carrier elements desired to be combined or at least one second inner plate group which can be connected to one other carrier element, at least one outer plate configured to rest said first inner plate group or said second inner plate group towards each other in a tight manner, at least one friction element which can increase rotational resistance with respect to each other, between the first inner plate group and the second inner plate group and between the outer plate and one of the inner plate groups, and at least one hyper-elastic dampening element. Thus, in case of quake, the buildings do not lose their momentum transferring capability and realize at least partially angular rotational movement, and destruction is prevented.

In a possible embodiment of the present invention, in order to be used in resting of the first inner plate group or the second inner plate group to each other in a tight manner, two outer plates are provided so as to be at the mutual sides thereof. Thus, the inner plates can be compressed from the two sides.

In another possible embodiment of the present invention, said outer plates compress the first inner plate group and the second inner plate group by means of a first bolt and at least one second bolt. Thus, the outer plates can be approached towards each other by means of the pre-tension force exerted onto the first bolt and the second bolt.

In another possible embodiment of the present invention, said first bolt is essentially connected so as to compress the first inner plate group or the second inner plate group through the centers thereof with pre-tension. Thus, the inner plates can be compressed through the center thereof.

In another possible embodiment of the present invention, said second bolt is essentially connected so as to compress the first inner plate group or the second inner plate group through the edges thereof with pre-tension. Thus, the inner plates can be compressed through the edges thereof.

In another possible embodiment of the present invention, in order to increase the resistance of the outer plate, the outer plate is preferably connected to at least one support profile. Thus, the rigidity of the outer plate is increased.

In another possible embodiment of the present invention, the first bolt and the second bolt are provided on the support element. Thus, the load is exerted to the support elements.

In another possible embodiment of the present invention, the first inner plate group or the second inner plate group comprises at least one each inner plates. Thus, the connection element is divided into layers and the pre-tension force, which exists on the bolts, can be transferred among each other.

In another possible embodiment of the present invention, said inner plates can be connected to the carrier element from one side thereof. Thus, the combination apparatus is connected with the carrier elements.

In another possible embodiment of the present invention, the inner plate comprises at least one support plate when required. Thus, the inner plates are connected with the carrier elements in a more resistant manner.

In another possible embodiment of the present invention, the inner plate comprises at least one inner plate extension when required. Thus, the inner plates are connected with the carrier elements in a more resistant manner.

In another possible embodiment of the present invention, said friction element is provided on the inner plates so as to be aligned with the support profile. Thus, bending of the outer profile due to the pre-tension force exerted to the friction element is prevented.

In another possible embodiment of the present invention, said friction element has at least one first friction element and at least one second friction element. Thus, a path is formed in order for the friction element parts to be able to slide on each other.

In another possible embodiment of the present invention, at least one first friction element is positioned on one of the first inner plate group and the second inner plate group or on the outer plates and at least one second friction element is positioned on the other plates in a manner aligning mutually with each other. Thus, the pre-tension force is loaded in an equal and controlled manner.

In another possible embodiment of the present invention, at least one first hyper-elastic dampening element and at least one second hyper-elastic dampening element are provided between the first inner plate group or the second inner plate group. Thus, reaction force is obtained in order to return to prior positions in case of a probable rotation in the combination apparatus.

In another possible embodiment of the present invention, on the hyper-elastic dampening elements, there is at least one rubber part or at least one metallic part. Thus, as the dampening characteristic is improved by means of the rubber part, the reaction of the hyper-elastic dampening element against high forces can be provided by means of the metallic part if used.

### BRIEF DESCRIPTION OF THE FIGURES

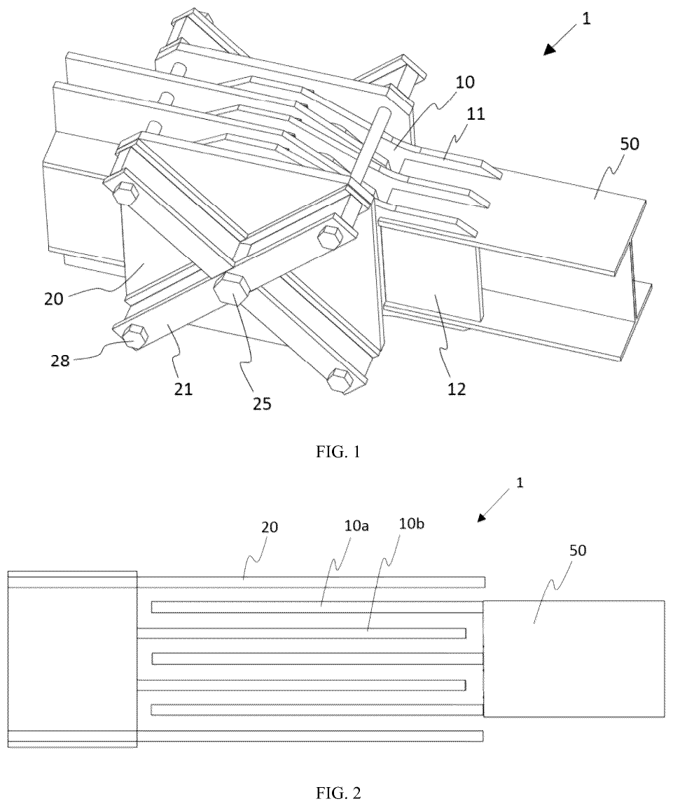

In FIG. 1, a representative perspective view of the subject matter combination apparatus is given.

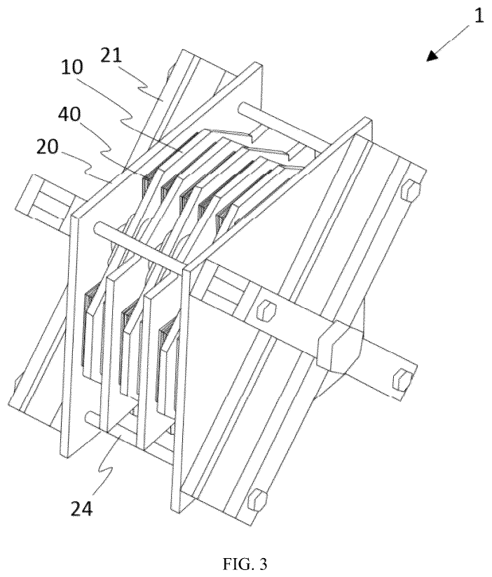

In FIG. 2, a representative top view of the outer plate and the inner plate groups positioned in the subject matter combination apparatus is given.

In FIG. 3, another representative perspective view of the subject matter combination apparatus is given.

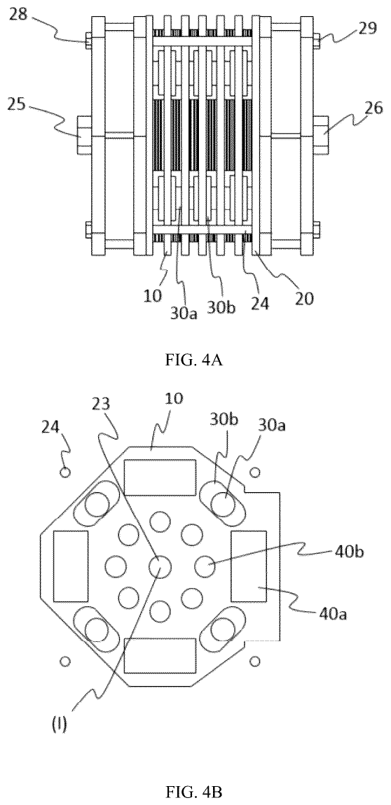

In FIG. 4, a representative top view and a representative cross-sectional view of the subject matter combination apparatus are given.

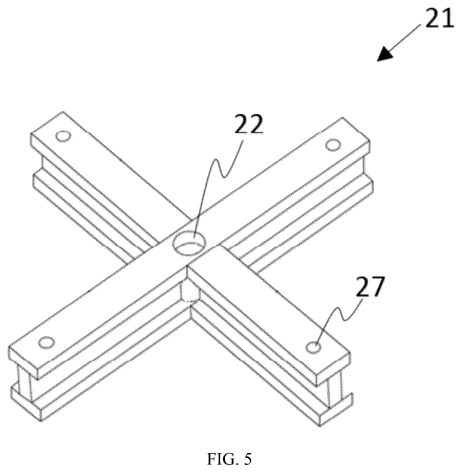

In FIG. 5, a representative perspective view of the support element positioned in the subject matter combination apparatus is given.

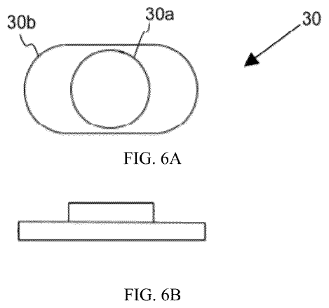

In FIG. 6, a representative top and lateral view of at least one friction element positioned in the subject matter combination apparatus is given.

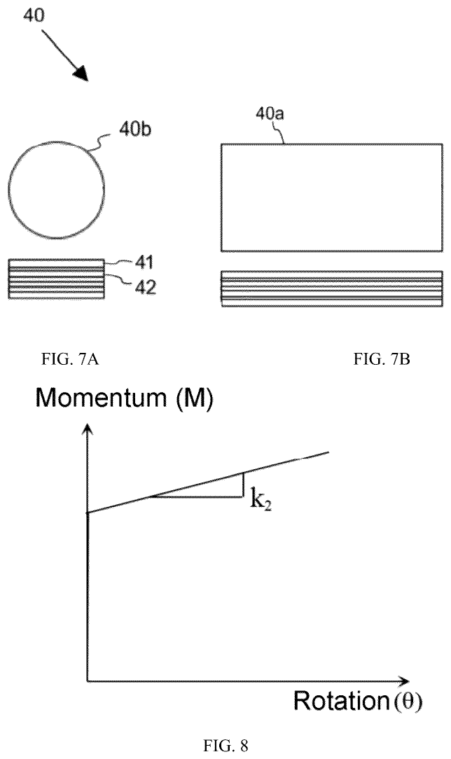

In FIG. 7, a representative frontal and lateral view of the hyper-elastic dampening element positioned in subject matter combination apparatus is given.

In FIG. 8, a representative graphical view of the momentum-rotation diagram formed when force is exerted to the subject matter combination apparatus is given.

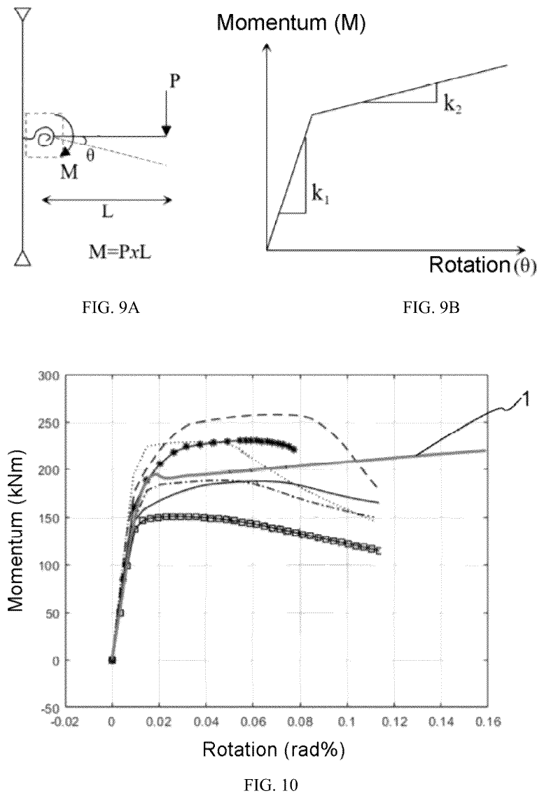

In FIG. 9, a representative graphical view of the momentum-rotation diagram formed in case the subject matter combination apparatus is connected to the carrier elements and in case a force is exerted to these carrier elements is given.

In FIG. 10, a representative graphical view comprising comparisons of the momentum-rotation diagram with respect to the elements of the prior art in case the subject matter combination apparatus is connected to the carrier elements and in case a force is exerted to these carrier elements is given.

### DETAILED DESCRIPTION OF THE INVENTION

In this detailed description, the subject matter is explained with references to examples without forming any restrictive effect only in order to make the subject more understandable.

With reference to FIG. 1, a representative perspective view of the subject matter combination apparatus (1) is given. Accordingly, the subject matter connection element (1) allows partial angular rotational movement which may occur due to reasons like vibration, quake, earthquake in fields particularly like construction machine technologies, and provides sustaining of momentum transferring capability without being damaged.

The combination apparatus (1) is used in connecting the main carrier elements (50) to each other in buildings. Thanks to this, by means of the angular rotational movement during shaking of the carrier elements (50), the occurrence of conditions like breaking, cracking, collapsing, etc is reduced and/or prevented. In the invention, said carrier items (50) are frame system elements like beams, columns which support the building.

The combination apparatus (1) connects the carrier elements (50) to each other and has at least one first inner plate group (10a) or at least one second inner plate group (10b). In FIG. 2, a representative top view of the inner plate groups (10a) and the outer plates (20) positioned in the subject matter combination apparatus (1) is given. The first inner plate group (10a) is connected to one of the carrier elements (50) to be connected to each other, and the second inner plate group (10b) is connected to the other one of the carrier elements (50). The first inner plate group (10a) or the second inner plate group (10b) has at least one inner plate (10) depending on the location where it will be used. In a possible embodiment of the present invention, said inner plate (10) is provided so as to be at least one in number and parallel to each other. The shape and dimensions of the inner plate (10) can change depending on the desired momentum and rotation values. The inner plates (10) are preferably in rectangular shape and in a chamfered form through their edges and are made of steel material. Thanks to this, the surface area of the inner plate (10) can be utilized at the highest level. When required, additional support plates (12) can be used, which provide continuation of the inner plate (10) by means of extending inwards the carrier element (50) at the side of the inner plate (10) connected to the carrier element (50). Moreover, when required and depending on the geometric condition of the carrier element (50), inner plate extensions (11) can be used. Thanks to this, the combination apparatus (1) can be connected in a rigid manner to the carrier elements (50). However, the inner plates (10) provided in the present invention are not limited with this and can also be produced in different manners as long as they do not affect the operation principle of the combination apparatus (1). The inner plates (10) divide the combination apparatus (1) to layers and provide transfer of the pre-tension force between layers.

In FIG. 3, another representative perspective view of the subject matter combination apparatus (1) is given. Accordingly, one each outer plates (20) are positioned at the outer vicinity of the inner plates (10). Said outer plates (20) provide the inner plates (10) which exist in between to be rested to each other in a tight manner. The outer plate (20) is essentially made of steel-based material and the dimensions thereof are changeable according to the location where the combination apparatus (1) will be used. A first bolt (23) and at least one second bolt (24) are used in order for the outer plates (20) to compress the inner plates (10). Said bolts are essentially used at the combinations of the structure elements. By means of the bolts, the outer plates (20) positioned mutually can be approached towards each other by means of pre-tension. Thanks to this, the inner plates (10) which remain in between are fixed to each other by means of resting to each other in a tight manner.

In FIG. 4, a representative top view and a representative cross-sectional view of the subject matter combination apparatus (1) are given. Accordingly, the first bolt (23) is passed through the first bolt hole (22) provided at the center (I) of the inner plate (10) and the outer plate (20). Thanks to this, the inner plates (10) are fixed through the center (I). In a possible embodiment example of the present invention, said second bolt (24) is positioned at the edges of the outer plates (20) in a manner not contacting the inner plates (10). Thanks to this, the inner plates (10) are compressed through the edges thereof. The first bolt holes (22) and the second bolt holes (27), needed for being able to use the first bolt (23) and the second bolt (24) in the combination apparatus (1), can be provided with predetermined shape and dimension on the inner plate (10) and the outer plate (20). The first bolt (23) is essentially in the form such that one side thereof has cap (25) and the other side thereof is threaded. The second bolt (24) is essentially in the form such that one side thereof has cap (28) and the other side thereof is threaded. Said first bolt cap (25) and said second bolt cap (28) are held respectively in a first bolt hole (22) and in at least one second bolt hole (27) provided on an outer plate (20) or on support profiles (21) and the first bolt nut (26) and the second bolt nut (29) are tightened respectively through said threaded parts and a pre-tension is formed in the combination apparatus (1). Moreover, after the tightening of said nut (26), it is preferred to fix said nut (26) on the bolt. Thanks to this, probable loosening in time is prevented.

Deflection may occur in time on the outer plates (20) due to the applied pre-tension forces. In order to prevent this, support profiles (21) are used. In FIG. 5, a representative perspective view of the support profile (21) positioned in the subject matter combination apparatus (1) is given. Accordingly, said support profile (21) is positioned essentially on the outward facing side of the outer plates (20) and provides rigidity to the outer plate (20). Preferably the support profiles (21) are at least one steel profile and are connected to the outer plate (20). Each support profile (21) can be produced with the dimensions needed for the combination apparatus (1). The first bolt holes (22) and the second bolt holes (27) can be provided which are needed for the first bolt (23) or for the second bolt (24) on the support profiles (21). The tension formed by the bolts during pre-tension is distributed on the support profile (21) and additional load application on the outer plates (20) is prevented and a more resistant structure is obtained.

In FIG. 6, a representative top and lateral view of at least one friction element (30) positioned in the subject matter combination apparatus (1) is given. Accordingly, said friction element (30) is positioned between the inner plates (10) and between the outer plate (20) and one of the inner plate groups (10a or 10b), and forms the rotation resistance. This rotation resistance provides determination of the first rotation rigidity of the apparatus and formation of momentum in the combination apparatus (1). In a possible embodiment of the present invention, the dampening element (30) consists of at least one first friction element (30a) and at least one second friction element (30b). Said first friction element (30a) and said second friction element (30b) transfers force by means of the friction effect onto each other. In a possible embodiment of the present invention, the first friction element (30a) has circular shape, and the second friction element (30b) has elliptical shape. The reason for this is to prevent area loss during sliding on each other. In a possible embodiment of the present invention, the first friction element (30a) can be made in square form, and the second friction element (30b) can be made in rectangular form. However, in this case, the friction element (30) covers more area on the inner plate (10); thus, this may lead to area problem for positioning of different elements, which will be hereunder described, on the inner plate (10). The first friction element (30a) and the second friction element (30b) are produced at predetermined dimensions and are positioned in the combination apparatus (1). The second friction element (30b) forms a path for sliding of the first friction element (30a) which tries to realize friction.

The operation manner of the friction elements (30) and positioning of the friction elements (30) on the combination apparatus (1) are as follows;

The first friction element (30a) and the second friction element (30b) are separately provided for each on the adjacent inner plates (10) and on the adjacent outer plate (20) and the inner plate (10). In other words, any of the friction elements (30) which try to realize friction at adjacent inner plates (10) is also joined at both sides, and at the outer plates (20), the other one of the friction elements (30) welded to the adjacent inner plate (10) is joined in a one-sided manner. Here, the subject which must be taken into attention is the need for joining the first friction element (30a) which tries to realize friction and the second friction element (30b) which tries to realize friction at different inner plate group. The reason for this form of the embodiment is that the first friction element (30a), which tries to realize friction as the combination apparatus (1) rotates, is desired to stay in the alignment of the support profile (21). As the combination apparatus (1) rotates, the relative rotation of the inner plate group whereon the first friction element (30a) is positioned is zero and the pre-tension force is distributed in a more uniform manner.

In FIG. 7, a representative frontal and lateral view of at least one hyper-elastic dampening element (40) positioned in subject matter combination apparatus (1) is given. Accordingly, said hyper-elastic dampening element (40) is configured to bring the combination apparatus (1) to the first position in case the plates make rotational movement with respect to each other between the inner plates (10) or between the inner plate (10) and the outer plate (20). In order to realize this, there is the hyper-elastic dampening element (40) positioned between the inner plates (10) or between the inner plate (10) and the outer plate (20). The hyper-elastic dampening element (40) essentially has elastomer characteristics. In a possible embodiment of the present invention, the hyper-elastic dampening element (40) is provided in pluralities of numbers and is positioned in a manner providing complete adherence in a manner aligned on the inner plates (10). There is at least one metallic part (41) and at least one rubber part (42) in the structure of the hyper-elastic dampening element (40). Said parts are joined in a manner providing complete adherence to each other in a layered form essentially on the hyper-elastic dampening element (40). The proportion of the metallic part (41) and the rubber parts (42) which form the hyper-elastic dampening element (40) can be determined as a result of the finite element analysis or calculations in accordance with the desired momentum and rotation values and in accordance with the sliding module value of the used rubber part (42) material.

In a possible embodiment of the present invention, the hyper-elastic dampening elements (40) comprise preferably two different types of areal geometries provided on the combination apparatus (1). These are the first hyper-elastic dampening element (40a) and the second hyper-elastic dampening element (40b). Said first hyper-elastic dampening element (40a) preferably has rectangular shape and said second hyper-elastic dampening element (40b) preferably has circular shape. In a different embodiment of the present invention, the preferred areal geometry can be different from the circular or rectangular form. Pluralities of two types of hyper-elastic dampening elements (40) can be provided on the combination apparatus (1). Preferably the first hyper-elastic dampening element (40a) is provided in a far manner from the center (I) on the inner plate. The second hyper-elastic dampening element (40b) is preferably closer to the center (I). Here, the dampening capacity of the first hyper-elastic dampening element (40a) with respect to the second hyper-elastic dampening element (40b) is proportional with the distance from the center or with the sliding rigidity. However, the second hyper-elastic dampening element (40b) provides contribution to the realization of slow loading and reduction of the load applied to the first hyper-elastic dampening element (40a). Thanks to this, the undesired permanent shape deformations at the metallic part of the hyper-elastic dampening element (40) are prevented.

In a possible usage of the present invention, the combination apparatus (1) is used for connecting different carrier elements (50) to each other. In a possible usage of the present invention, in accordance with the combination apparatus configuration depending on the intensity of any quake, while any of the first inner plate group (10a) and the second inner plate group (10b) and the outer plates (20) move simultaneously in the same direction, it rotates relatively at least partially with respect to the other inner plate group. During this rotation, the friction elements (30) are in continuous contact with each other and give reaction related to stopping of this movement. However, as the intensity of the quake increases, this reaction force is exceeded and the movement continues. In this case, the reaction force exerted by the hyper-elastic dampening elements (40) increases.

As a result of the analyses made and the developed calculation steps, the momentum value which can be carried by the combination apparatus (1) is determined as given below.

M=n·(T_{S}·μ·x_{S}+k_{E}·θ·x_{E}²)

Here, n: inner plate number, T_{S}: total pre-tension force, μ: friction coefficient, xₛ the distance of the steel plates, which try to realize friction, to the first bolt, k_{E}: the rigidity of the hyper-elastic dampening element (40), θ: the rotation value of the combination apparatus (1), x_{E}: the distance of the hyper-elastic dampening element (40) to the center.

In FIG. 8, a representative graphical view of the momentum-rotation diagram formed when a monotonic force, in other words, a single-directional force is exerted to the subject matter combination apparatus (1) is given. Here, the beginning rigidity is infinite and the friction force formed by friction elements (30) has not been yet overcome, in other words, there is no rotational movement in the combination apparatus (1). The second inclination (k₂) is the secondary rigidity and here, mostly the hyper-elastic dampening elements (40) have contribution, and the contribution of the friction elements (30) is relatively less.

In FIG. 9, a representative graphical view of the momentum-rotation diagram formed in case the subject matter combination apparatus (1) is connected to the carrier elements (50) and in case a monotonic force, in other words, a single-directional force is exerted to these carrier elements is given. Here, the beginning rigidity is k₁ and it is mostly obtained by means of elastic deformation of the beam as a result of the contribution of momentum formed by the friction elements (30). Meanwhile, in the combination apparatus (1), there is no rotational movement. The second inclination (k₂) is the secondary rigidity and here, mostly the hyper-elastic dampening element (40) has contribution, and the contribution of the friction elements (30) is very slight. In the design of the combination apparatus (1), any different embodiment which will obtain this momentum-rotation curve can be considered. In other words, positioning of the dampening elements (30) and the hyper-elastic elements (40) can be changed as long as this is proved.

In FIG. 10, a representative graphical view comprising differences of the momentum-rotation diagram with respect to the elements of the prior art in case the subject matter combination apparatus (1) is connected to the carrier elements (50) and in case a force is exerted to these carrier elements (50) is given. Here, the momentum-rotation curve obtained for an example of the combination apparatus (1) is given as comparative with the analysis results obtained in different combination elements known in the art. In order to be able to realize comparison, the same beam and column profiles have been used in each combination. As seen here, the momentum carrying capacity is at the level of other combinations. The distinctive characteristic of the combination apparatus (1) is that while damages are observed at 4% rotation values in the other combination items, damage with 10% rotation value has not been observed in the combination where the subject matter combination apparatus (1) exists. Here, the important factor is to avoid subjecting the hyper-elastic dampening element (40) to torsion effect. As the displacement realized by the hyper-elastic dampening elements (40) increases, the value of force carried gradually increases in an opposite manner to the friction elements (30). Thus, they have characteristic of increasing the second curve, which approximately continues in a fixed manner, of the momentum-rotation curve. However, at very big displacement values, since the sliding deformation also increases depending on the height of the hyper-elastic dampening elements (40), this must be delimited. As the distance of the hyper-elastic dampening elements (40) to the rotation center (I) increases, the carried momentum increases and these distances are determined by calculation. Thanks to the displacement realized by the rotation of the combination apparatus (1), the secondary rigidity of the combination apparatus (1) in the hysteretic curve and the ductility thereof increase and provide characteristic of recalling of the rotational movement realized by the combination apparatus (1).

By means of all these embodiments, the combination apparatus (1) provides meeting of the sufficient rigidity against earthquake and dampening need in a sustainable manner at the combinations in reinforced concrete and steel and prefabricated buildings. The combination apparatus (1) provides non-damaged rotation capability under a bending capacity protected without exceeding the bending capacity of the combinations in buildings and makes the bending rigidity of structure elements sustainable and provides non-damaged dampening characteristic. Thanks to this, structures which are protective against earthquake are obtained for humanity and the damaging of the public by earthquake is prevented.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

1 Combination apparatus
10 Inner plate
10a First inner plate group
10b Second inner plate group
11 Inner plate extension
12 Support plate
20 Outer plate
21 Support profile
22 First bolt hole
23 First bolt
24 Second bolt
25 First bolt cap
26 First bolt nut
27 Second bolt hole
28 Second bolt cap
29 Second bolt nut
30 Friction element
30a First friction element
30b Second friction element
40 Hyper-elastic dampening element
40a First hyper-elastic dampening element
40b Second hyper-elastic dampening element
41 Metallic part
42 Rubber part
50 Carrier element
(I) Center

What is claimed is:

1. A combination apparatus for use in connecting carrier elements to each other in buildings, wherein a flexibility is provided by a building, wherein the building is not damaged against quake, the combination apparatus comprises:
at least one first inner plate group, wherein the at least one first inner plate group is allowed to be connected to a first one of the carrier elements desired to be combined or at least one second inner plate group, wherein the at least one second inner plate group is allowed to be connected to a second one of the carrier element,
at least one outer plate configured to rest the first inner plate group or the second inner plate group towards each other in a tight manner,
at least one friction element, wherein the at least one friction element is allowed to increase a rotational resistance with respect to each other, between the first inner plate group and the second inner plate group and between the outer plate and one of the first and second inner plate groups and
at least one hyper-elastic dampening element, wherein the at least one hyper-elastic dampening element is allowed to provide a reaction force for returning the combination apparatus to a first position of the combination apparatus in case of a probable rotation and positioned between inner plates or between the inner plate and the outer plate.

2. The combination apparatus according to claim 1, wherein in order to be configured in resting of the first inner plate group or the second inner plate group to each other in the tight manner, two outer plates are provided to be at mutual sides of the two outer plates.

3. The combination apparatus according to claim 2, wherein the outer plates compress the first inner plate group and the second inner plate group by means of a first bolt and at least one second bolt with pre-tension.

4. The combination apparatus according to claim 3, wherein the first bolt is connected to compress the first inner plate group, the second inner plate group and the outer plates through centers of the first inner plate group, the second inner plate group, and the outer plates with pre-tension.

5. The combination apparatus according to claim 4, wherein the second bolt is connected to compress the first inner plate group, the second inner plate group and the outer plates through edges of the first inner plate group, the second inner plate group, and the outer plates with pre-tension.

6. The combination apparatus according to claim 1, wherein in order to increase a resistance of the outer plate, the outer plate is connected to at least one support profile.

7. The combination apparatus according to claim 6, wherein the support profile is connected to the outer plate by being positioned at a side of the outer plates facing outwardly.

8. The combination apparatus according to claim 3, wherein a first bolt cap and a second bolt cap are provided on the outer plate or on a support profile and threaded parts are compressed by means of a first bolt nut and a second bolt nut.

9. The combination apparatus according to claim 1, wherein the first inner plate group or the second inner plate group comprises at least one each inner plates.

10. The combination apparatus according to claim 9, wherein the inner plates can are allowed to be connected from one side with the carrier element.

11. The combination apparatus according to claim 9, wherein the inner plate comprises at least one support plate when required.

12. The combination apparatus according to claim 9, wherein the inner plate comprises at least one inner plate extension when required.

13. The combination apparatus according to claim 6, wherein the friction element is provided on the inner plates and the outer plates to be aligned with the support profile.

14. The combination apparatus according to claim 1, wherein the friction element has at least one first friction element and at least one second friction element.

15. The combination apparatus according to claim 14, wherein the first friction element is positioned on a first one of at least one of the first inner plate group and the second inner plate group and
the at least one second friction element is positioned on a second one of the at least one of the first inner plate group and the second inner plate group, and
on the outer plates, the friction elements are positioned in a manner aligning mutually with each other as a first one of the first and second friction elements is joined to an adjacent inner plate and a second one of the first and second friction elements is joined to a face of the outer plate.

16. The combination apparatus according to claim 1, wherein at least one first hyper-elastic dampening element and at least one second hyper-elastic dampening element are positioned between the first inner plate group and the second inner plate group and between the outer plate and one of the first inner plate group and the second inner plate group.

17. The combination apparatus according to claim 16, wherein at least one rubber part and at least one metallic part are provided on the hyper-elastic dampening elements.

18. The combination apparatus according to claim 6, wherein a first bolt cap and a second bolt cap are provided on the outer plate or on the support profile and threaded parts are compressed by means of a first bolt nut and a second bolt nut.
